(19) United States
(12) Patent Application Publication
(10) Pub. No.: US 2020/0306589 A1
(43) Pub. Date: Oct. 1, 2020

(54) SYSTEMS AND METHODS FOR REAL-TIME FEEDBACK AND ATHLETIC TRAINING ON A SMART USER DEVICE

(71) Applicant: FitLens, Inc., Foster City, CA (US)

(72) Inventor: Ahmad JABR, Foster City, CA (US)

(21) Appl. No.: 16/830,002

(22) Filed: Mar. 25, 2020

Related U.S. Application Data
(60) Provisional application No. 62/823,574, filed on Mar. 25, 2019.
(60) Provisional application No. 62/827,712, filed on Apr. 1, 2019.
(60) Provisional application No. 62/827,718, filed on Apr. 1, 2019.
(60) Provisional application No. 62/827,722, filed on Apr. 1, 2019.

(51) Int. Cl. A63B 24/00; A63B 71/06; G06T 13/40; G06F 3/16

(52) U.S. Cl. CPC A63B 24/0075; A63B 24/0062; A63B 71/0622; G06T 13/40; A63B 2225/52; A63B 2024/0065; A63B 2024/0068; A63B 2071/0636; G06F 3/167

(57) ABSTRACT

A smart exercise device configured to present a user with a user interface at least partially via a display, receive a selection of a trainer via the user interface and communicate the selection to a cloud service via the communication interface, receive a selection of an exercise associated, download a video of the selected exercise, the video comprising a training portion, cause the training portion of the video to be displayed while simultaneously activating the camera in order to capture video of the user performing actions depicted in the training portion of the video, analyze the captured video in order to match movements of the user depicted in the video to movements in the training portion of the video, generate trackable feedback, and provide the feedback via the user interface.

### CROSS-REFERENCE TO RELATED APPLICATIONS

This patent application claims the benefit of and priority under 35 U.S.C. § 119(e) to U.S. Provisional Patent Application Nos. 62/823,574, filed Mar. 25, 2019, 62/827,712, filed Apr. 1, 2019, 62/827,718, filed Apr. 1, 2019, and 62/827,722, filed Apr. 1, 2019. The disclosures of each of which are incorporated herein by reference in their entireties.

### BACKGROUND

### 1. Technical Field

The embodiments described herein are related to systems and methods for guided athletic training, and more specifically to an online platform for guided training that provide real-time feedback and training in order to ensure proper execution and maximum results.

### 2. Related Art

There is a large emphasis on health today. People are looking for convenient ways to eat healthy and exercise in order to live well. As a result, a plethora of information, devices, and applications have launched over the last decade designed to allow consumers to monitor their health, get healthy recipes, access online workouts, etc.

But with respect to exercise, it is still difficult for consumers to understand how they can exercise effectively and efficiently. First, people are busier than ever and so efficient, time effective workouts are important. But a major barrier is simply getting to the gym where maybe one can get some guidance and support. But this often means hiring a personal trainer, which can be expensive and is not necessarily convenient.

As a result, fitness apps have become popular. But knowing what app., what exercises, how and whether you are performing the movements correctly can limit the effectiveness of these apps. Initially, twenty years ago or so, home workouts on tape or CD were popular, which became, e.g., YouTube videos, and then fitness apps. But these tend to be faddish and popular for a short while for the reasons cited above.

More recently, smart home gym equipment has replaced the conventional home gym equipment, such as Peloton, Nordic track, etc., which online instruction and classes on how to use the equipment. But the problems mentioned above persist.

### SUMMARY

Systems and methods for online fitness training that provides real-time feedback and instruction are described herein.

According to one aspect, a smart exercise device comprises a camera configured to capture video of a user of the smart exercise device; a display; a communication interface configured to allow the smart exercise device to communicate with a cloud service; a processor configured to execute instructions, the instructions configured to cause the processor to perform the steps of: present the user with a user interface at least partially via the display, receive a selection of a trainer via the user interface and communicate the selection to the cloud service via the communication interface, receive a selection of an exercise associated with the trainer via the user interface and communicate the selection to the cloud service via the communication interface, download a video of the selected exercise via the communication interface, the video comprising a training portion, cause the training portion of the video to be displayed on the display while simultaneously activating the camera in order to capture video of the user performing actions depicted in the training portion of the video, analyze the captured video in order to match movements of the user depicted in the video to movements in the training portion of the video, generate trackable feedback, and provide the feedback via the user interface.

These and other features, aspects, and embodiments are described below in the section entitled “Detailed Description.”

### BRIEF DESCRIPTION OF THE DRAWINGS

Features, aspects, and embodiments are described in conjunction with the attached drawings, in which:

FIG. 1 is a diagram illustrating an example system for real-time training feedback in accordance with one embodiment;

FIG. 2 is a flow chart illustrating an example trainer flow in accordance with one example embodiment;

FIG. 3 is a flow chart illustrating an example user flow in accordance with one example embodiment;

FIG. 4 is a flow chart illustrating an example trainer flow for a workout plan in accordance with one example embodiment;

FIG. 5 is a flow chart illustrating an example user flow for a workout plan in accordance with one example embodiment;

FIG. 6 is a flow chart illustrating an example performance review flow for a workout plan in accordance with one example embodiment;

FIG. 7 is a flow chart illustrating an example user flow that can also combine data from another sensor or device;

FIG. 8 is a flow chart illustrating an example one-shot tracking flow for a workout plan in accordance with one example embodiment

FIG. 9 is a block diagram illustrating an example wired or wireless system that can be used in connection with various embodiments described herein;

FIGS. 10A and 10B are diagrams illustrating feedback to the user;

FIG. 11 is a diagram illustrating performance information as presented to a user;

FIG. 12 is a diagram illustrating some of the information that the user can access concerning their performance and progress; and

FIG. 13 is a diagram of certain features that can be added.

### DETAILED DESCRIPTION

The embodiments described herein are by way of example only and should not be seen as limiting the systems and methods described to specific embodiments or implementations. For example, it will be understood that there are many ways to implement a cloud architecture and unless specifically noted, nothing where should be seen as limiting the embodiments to a particular architecture. Similarly, certain aspects described can be implemented on a variety of devices and nothing herein should be seen as limiting the embodiments to specific devices are device types.

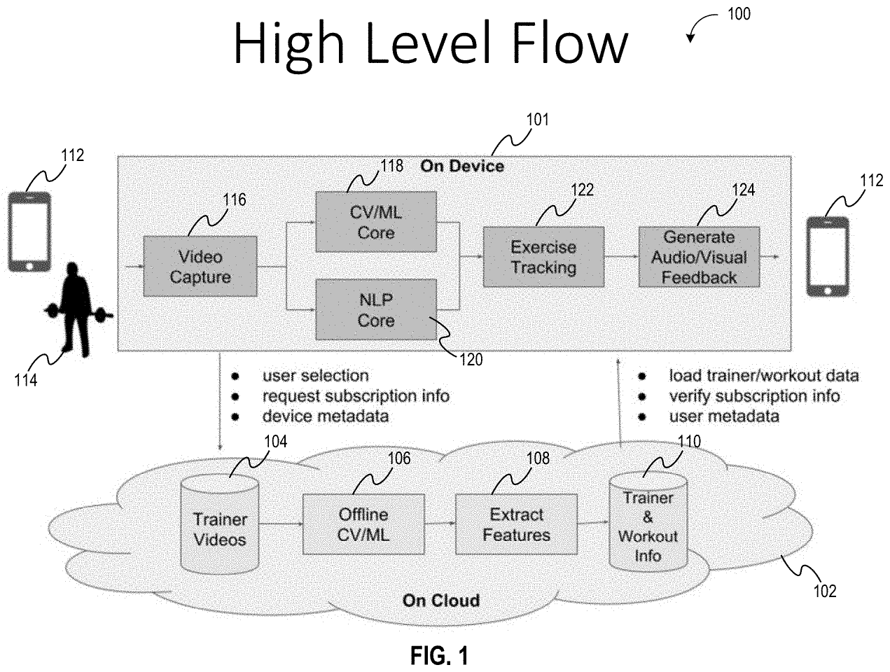

FIG. 1 is a diagram illustrating a system 100 for real-time training feedback in accordance with one example embodiment. System 100 comprises a plurality of users, of which exemplary user 114 is shown that use a personal device 112, such as a smartphone, tablet, laptop, etc., running one or more applications configured to enable the device 112 and/or user 114 to perform the steps and processes described herein, to access various resources in cloud architecture 102.

User 114 can select via the application 101 running on device 112 to access and play training videos that are stored in cloud 102. But in order to ensure optimum results, the user 114 first does training exercises or movements while videoing themselves and receives real-time feedback through device 112 to ensure they are and are capable of doing various movements and exercises correctly. Then the user can begin the training with the understanding of how to do the key movements or exercises and thereby get the most benefit.

The on device application (App.) 101 can comprise a video capture component 116, a Computer Vision (CV)/Machine Learning (ML) core component 118, a Natural Language Processing (NLP) core component 120, an exercise tracking component 122 and a feedback generation component 124. It will be understood that terms like component or core or the like refer to the combination of hardware and software resources needed to carry out the various functions, processes, capabilities, etc., described.

Cloud 102 can comprise a video data base 104 of training videos stored in one or more storage devices, an offline CV/ML component 106, a feature extracting component 108, and trainer database 110 of trainers and related workout information. It will be understood that video database 104 and trainer database 110 can be combined and/or stored within the same storage device(s).

In order to achieve the above functions there are two flows, the trainer flow and the user flow. These flows can be illustrated in the context of a single exercise to demonstrate the tracking and feedback generation.

Trainer Flow:

This is an on-the-cloud flow where trainer uploads/and or capture the exercise videos, labels the video and algorithms extract what are termed features from that video and store them for later when it is needed for user flow tracking.

User Flow:

That is on device 112 flow where the user 114 selects an exercise and particular trainer. The on device App uses a camera included in or associated with device 112 to track the user 114 while he or she performs the exercise. The tracking will be based on matching his/her exercise to the trainer's that has been previously recorded and extracted and stored on the cloud 102 and or pre-buffered to the device 112.

In certain embodiments, the on device App. can cause device 112 to capture audio through speech recognition engine for interactivity.

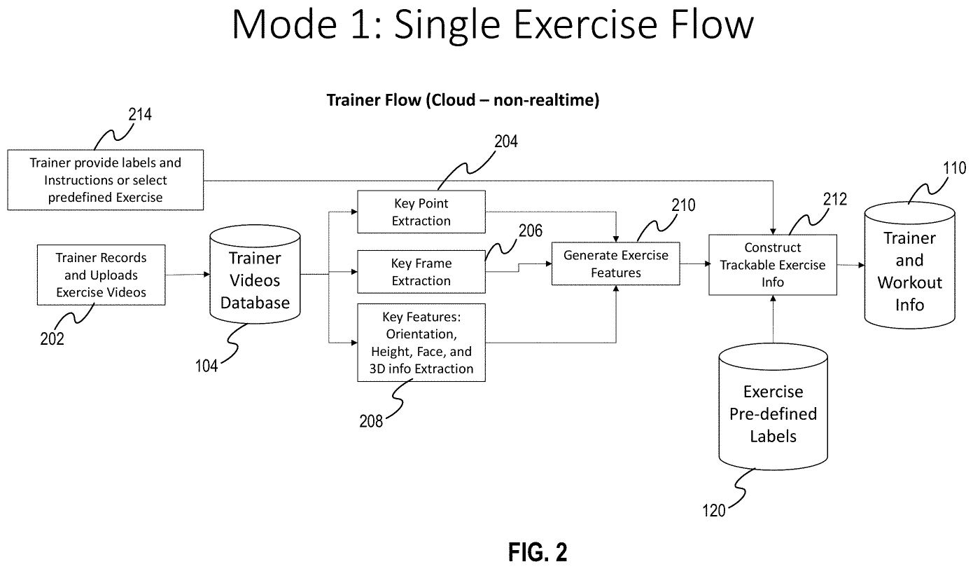

FIG. 2 is a flow chart illustrating an example trainer flow in accordance with one example embodiment. In step 202, the trainer records and uploads an exercise video into database 104. The offline CV/NL component 106 and feature extraction component 108 can then perform key point extraction (step 204), key frame extraction (206), and key Feature extraction (step 208) in order to generate exercise features in step 210 that can be used to construct trackable exercise information that can be used to allow the exercise tracking module 122 to track the user performing the key movements or exercises and generate appropriate feedback via feedback generation component 124.

The trainer can provide certain labels and/or instructions, and can select predefined movements or exercise for tracking and provide this information for use in constructing the trackable exercise information in step 212. In certain embodiments, certain pre-defined labels, e.g., stored in a pre-defined label database 120, which is part of the cloud architecture 102 although not shown in FIG. 1, can also be used in constructing the trackable exercise information in step 212.

For key point extraction in step 204, the offline CV/ML component 106 can be configured to track certain points, e.g., on the body from frame to frame with in the video in order to “understand” the positions, poses, and movements in involved. The points can be correlated, e.g., with key body parts like bones, key points like mid torso, chin/head location, waist, location, knee location, etc.

For key frame extraction in step 206, the offline CV/ML component 106 can then determine key features such as the orientation of the individual in the video, the height, the location of the face, hips, knees, etc., and can generate 3D information that can allow for accurate tracking by allowing the system to adjust for these features for different individuals.

For key feature extraction in step 208, the offline CV/ML component 106 can locate key features like the orientation of the user within the frames, the height of the person, the location of the head, torso, waist, hips, etc. Facial recognition can be used to help with orientation and other feature detection. 3D information can then be extracted to help generate the features in step 210.

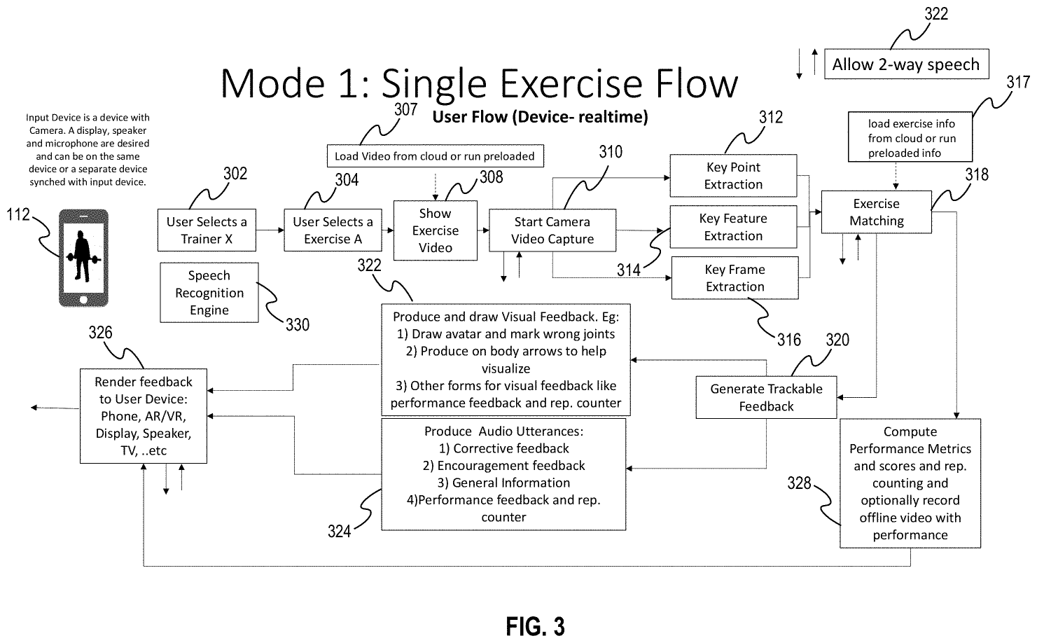

FIG. 3 is a flow chart illustrating an example user flow in accordance with one example embodiment. First, in step 302, the user uses the App. 101 to select a trainer from trainer database 110, e.g., based on the trainer and workout information. In step 304, the user can then select a video form database 104. The Video, or a training video associated therewith, is then loaded from cloud 102 in step 306 or may have bene preloaded. In step 308, the video is displayed on device 112 and App. 101 starts capturing video of the user via video capture module 116.

In steps 312, 314, and 316, the CV/ML core 118 can then perform key point, key feature extraction, and key frame extraction as described above, but now on the user trying to perform the training movements and positions. The training the trackable exercise information and the features, labels, etc., included therein can then be loaded in step 317, or may have been preloaded. Exercise tracking module 122 can then track and match the users movements with the training information in step 318.

In step 320, trackable feedback information can be generated and output via feedback component 124, which can control the User Interface (U/I) of device 112, in step 326. For example, visual feedback be generated in step 322 and audio feedback generated, e.g., by NLP core 120, in step 324.

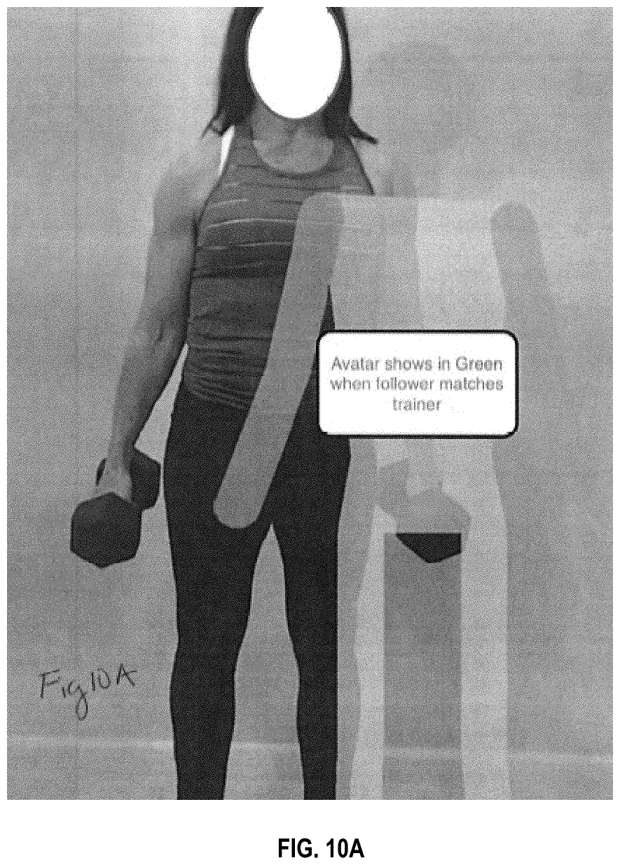

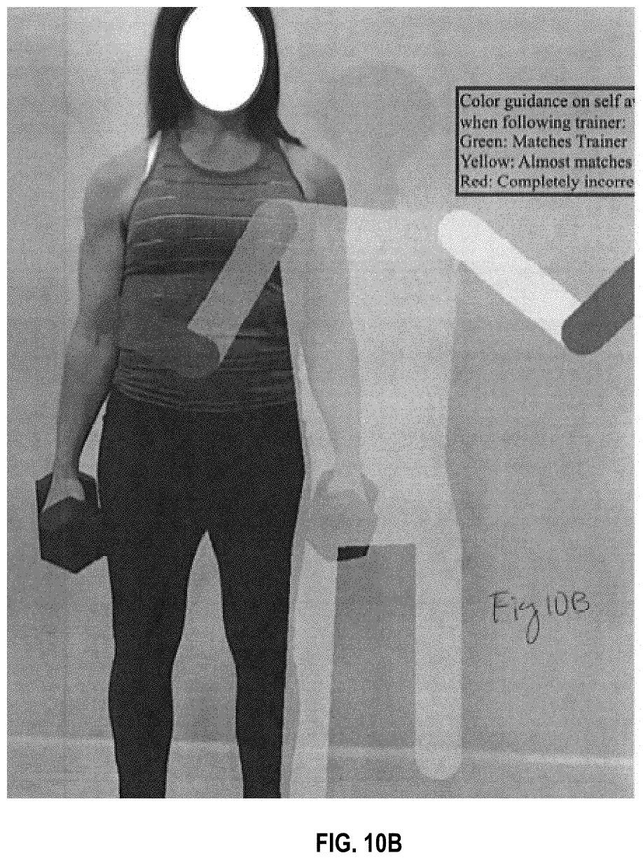

Generating visual feedback in step 322 can comprise creating and outputting an avatar and mark wrong joints, e.g., if the user's arm is in the wrong position, the Avatar's corresponding arm may be red or yellow, if it is only slightly off. Some other visual indicator can also be used. FIGS. 10A and 10B illustrate the use of an avatar with color coded feedback. The person in the video can be the trainer performing the move the correct way. As the user tries to mimic the training, the avatar appears and illustrates whether they are doing it correctly.

In another embodiment, the video of the user performing the exercise can be shown to the user on device 112 in real-time. Lines or arrows on the user's body, with or without coloring such as green for correct, yellow for slightly off, and red for of, on the user's body.

App. 101 can also cause device 112 to generate audio feedback that provides corrective action, encouragement, or general information to the user as the user attempts to the user as they attempt to perform the training moves and positions. The audio feedback can be combined with or in lieu of at least some of the visual feedback.

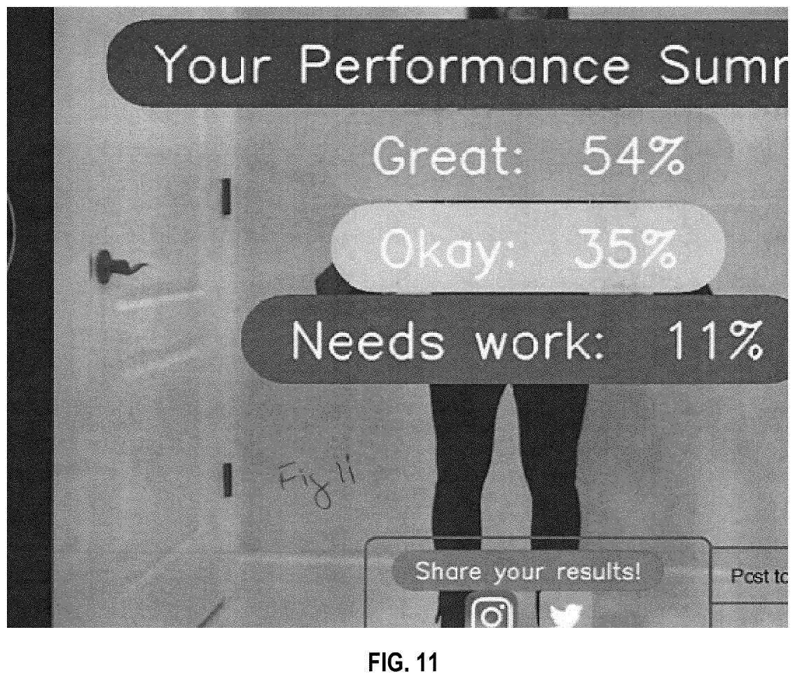

In certain embodiments, performance metrics, performance scores, repetition counting, can be generated in step 328 and can be displayed in step 326 either on request or as part of the feedback generated as illustrated in FIG. 11.

As illustrated in steps 330 and 332, a speech recognition component can be included in device 112 that allows two-way communication with App. 101. For example, the user can provide audio commands to select the trainer, video, etc. In certain embodiments the user may be able to audibly ask questions and solicited help and receive audible feedback.

Once the user is comfortable that they are and can perform the moves and positions, the user can then go on and perform the a certain number of repetitions, etc., for example, as instructed by the video.

In certain embodiments, the user can select a trainer and the trainer can define a workout plan, e.g., daily workout plan, for the user. The performance metrics (step 328) can be saved and tracked over time. Moreover, the workout plan can be updated over time based on the performance information. This can be done automatically as noted below.

There are three work flows that can be associated with such a workout plan as described above.

Trainer Flow:

This is an on-the-cloud flow where trainer uploads/and or capture the exercise videos, labels the video and our algorithms do extract the features from that video and store it for later when it is needed for User Flow tracking.

User Flow:

That is on device flow where user selects exercise and particular trainer. And The App uses camera from device to track his/her exercise. The tracking will be based on matching his/her exercise to the trainer's that has been previously recorded and extracted and stored on the cloud and or pre-buffered to the device. It also optionally captures audio through speech recognition engine for interactivity. Performance is computed real-time.

Performance Review Flow:

This an additional step in which a trainer has option of reviewing user performance and adjusting workout plan. This also can be done automatically if ML/CV algorithm finds from scores exercise is becoming too difficult or too easy for user.

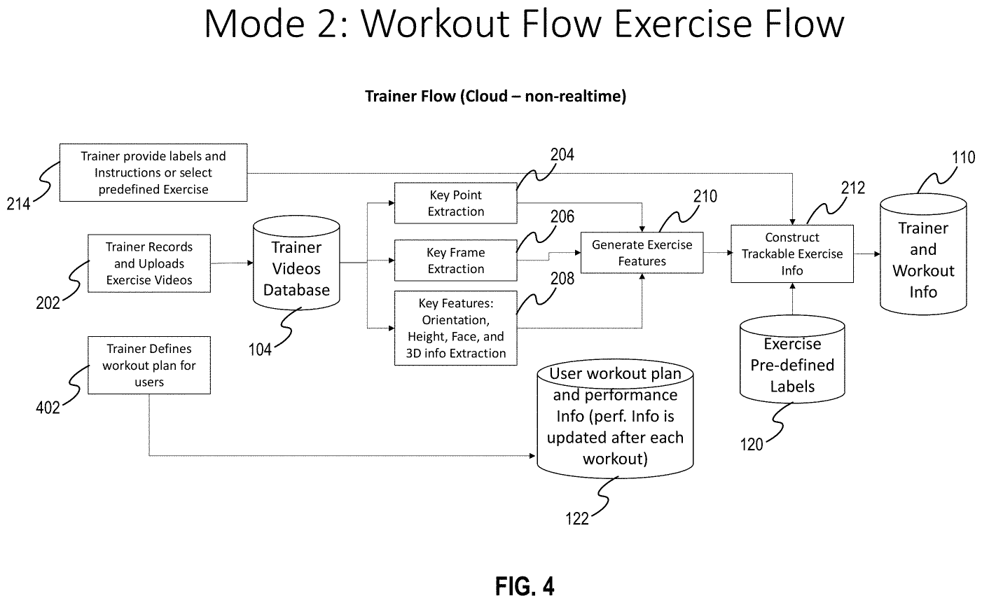

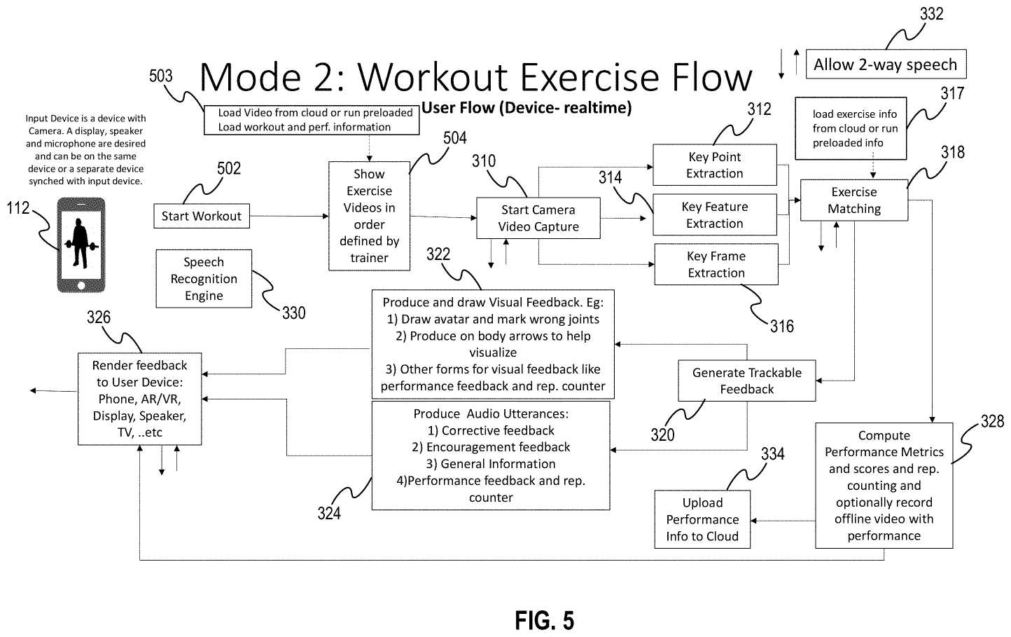

FIG. 4 illustrates a flow chart illustrating an example trainer flow and FIG. 5 is a flow chart illustrating an example user flow in relation to generating and implementing a workout plan in accordance with one example embodiment. These flows are very similar to the flows of FIGS. 2 and 3 respectively, only now the trainer defines the workout plan for the user 402 and stores the plan in a workout database 122 that can be part of the cloud architecture 102, even though it is not shown. The video database 104 would also then have all the related videos for the plan.

Now when the user starts the workout in step 502, the videos defined by the trainer can loaded in step 503, if they are not already pre-loaded, and shown in device 112 in step 504 in the correct order.

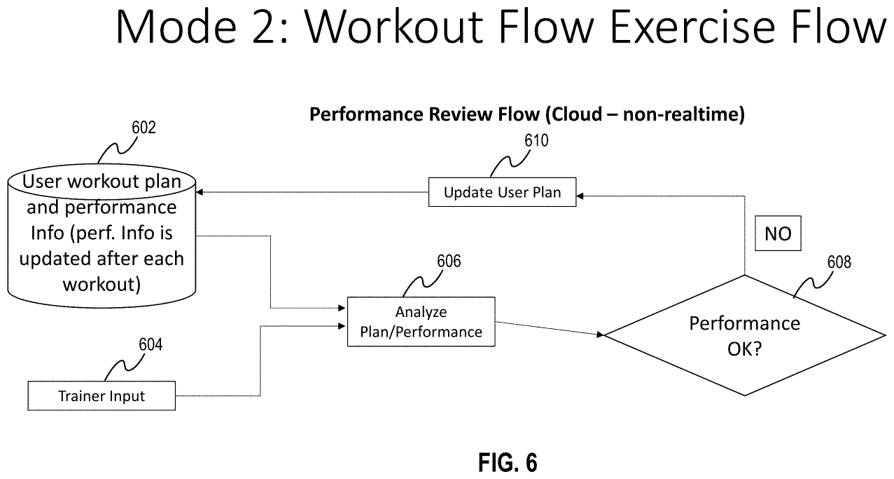

In FIG. 6, a performance review can be performed. Thus, in step 602, the workout plan and performance information can be updated after each work out and review periodically or after each work out to determine whether the plan should be changed in step 606. The analysis can use or be based on trainer and/or doctor or other input received in step 604. If it is determined that the performance is fine and no changes are needed, the plan is unaltered. Bur if it is determined that the plan should be changed, then it can be updated in step 610.

In certain embodiments, the offline CV/ML component 106 and/or component 118 can be configured to analyze the tracking data and automatically change the workout, e.g., if the user has master a certain exercise or difficulty level, is having trouble with the exercises, or the exercises appear to not be beneficial or achieving the desired result.

In other words, the various CV/ML components can be configures to take the various inputs, tracking data, and feedback and run algorithms to determine whether the exercises, the exercise plan, or both should be modified. For example, if computer vision analysis in conjunction with the tracking information illustrates that the user just cannot perform a certain move, or cannot perform the move with a certain amount weight, or their facial expressions indicates unwarranted discomfort, or the user is audibly expressing pain or difficulty, then this can lead to a determination that the exercise should be modified, e.g., to use less weight, or even eliminated or replaced with another exercise.

Also, in certain embodiments, the performance data can be converted into a performance score and changes can be made based on the score at any particular time, e.g., after a particular workout, a cumulative score, changes in the score over time, etc.

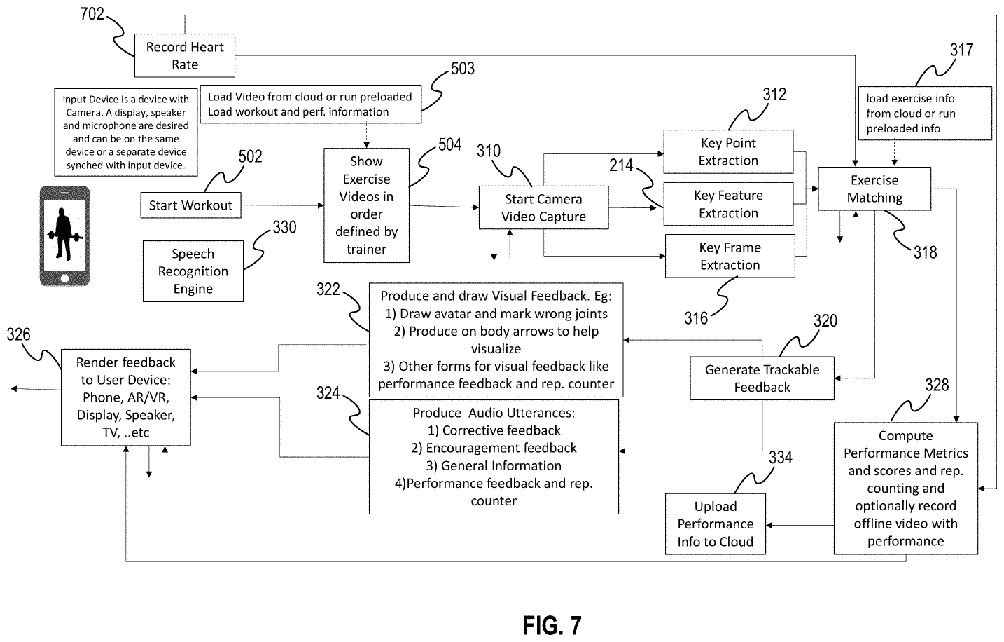

In certain embodiments, as illustrated in FIG. 7, the output 702 from various other sensors can be used in the exercise tracking step 318 and/or the capturing of performance metrics in step 328, which means this information can also be used in 606 to determine whether to modify the work out plan. These other sensor can include sensors within the user's device 112, such as gyroscopes and GPS information, which can also be gained from other devices, household sensors such as thermostats, as well as heart rate monitors, pedometers, weight scales, blood pressure cuffs, etc. The sensor information may be communicated directly to App. 101 or may be communicated to another website and then accessed by App. 101 or cloud 102, or it can be communicated directly to cloud 102.

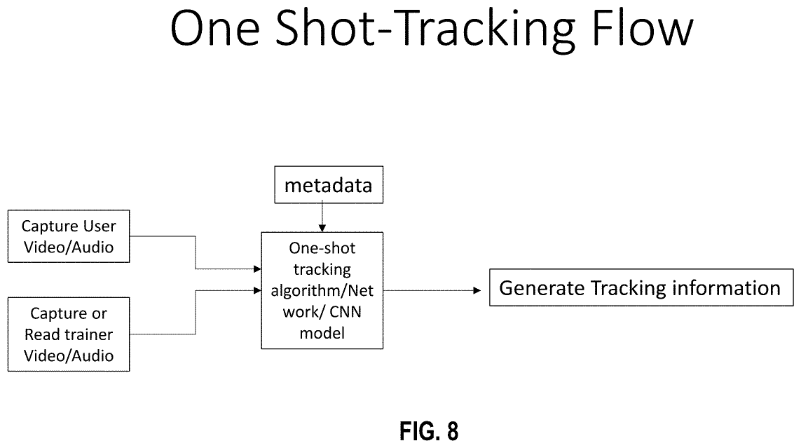

FIG. 8 is a diagram illustrating a flow chart for a one-sot tracking flow.

In certain embodiments, while in the workout out mode reward points can be generated based on performance. The reward points can used by 3rd party to motivate user to workout. Example if company provide app to its employees.

Live stream: In this case the trainer is doing the workout in real-time and broadcasting to all his followers. The system can do the same flow to trainer as for the user real-time and do matching. Also the trainer can be provded real time access to the feedback of the user to help them do corrections if needed.

Peer to Peer: Similar to live stream except a more experienced user can act as trainer and use his videos to real time show other friend/user.

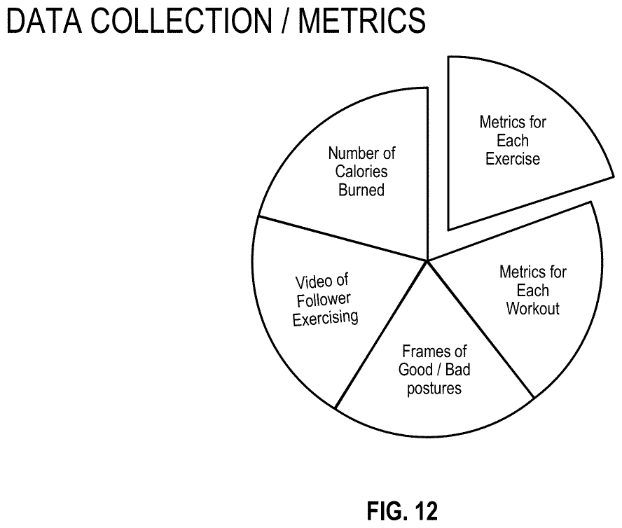

FIG. 12 is a diagram illustrating some of the information that the user can access concerning their performance and progress either via a portal to cloud 102 or via App. 101.

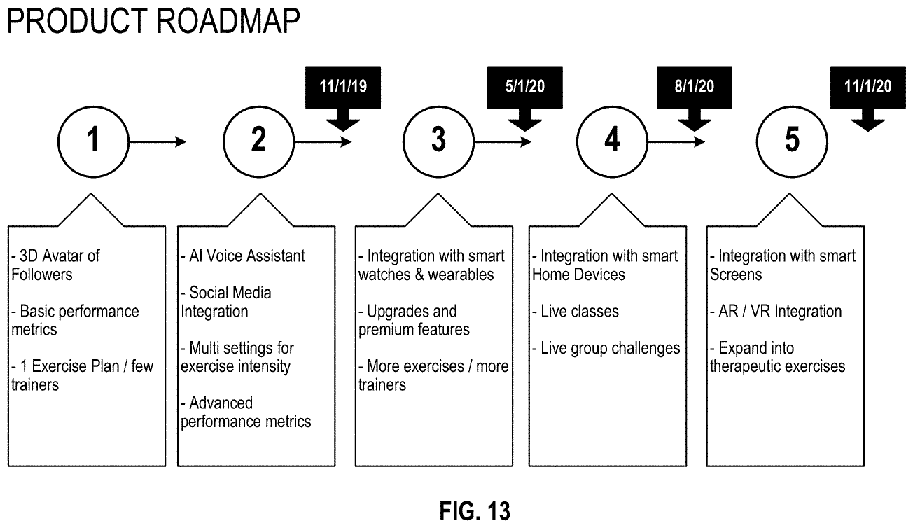

FIG. 13 is a diagram of certain features that can be added.

It should also be noted that while generally the embodiments described above are described in relation to a cloud based embodiment, all or some of the cloud functionality can be included on device 112. For example, the trainer flows can be performed using device 112 with the appropriate software and hardware resources to perform the above functions and capabilities. Similarly, the user flows can also be performed using device 112. In such instances, the user may still access the cloud or the Internet to access the trainer videos, or as noted they can be preloaded on the users device. Thus, for example the user may select a trainer through App. 101 and then any videos produced by that trainer can be automatically or selectively pre-loaded on the user's device 112.

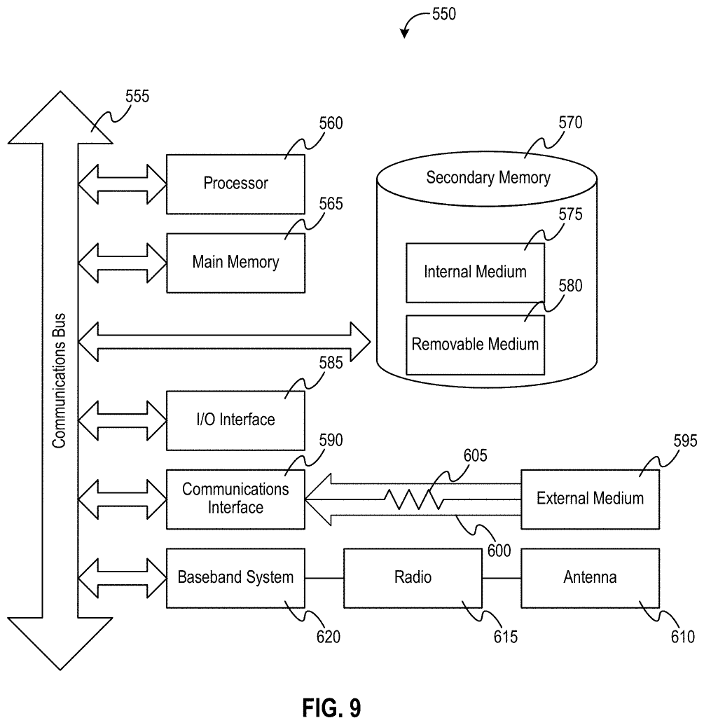

FIG. 9 is a block diagram illustrating an example wired or wireless system 550 that can be used in connection with various embodiments described herein. For example the system 550 can be used as or in conjunction with one or more of the platforms, devices or processes described above, and may represent components of device, the corresponding backend server(s), and/or other devices described herein. The system 550 can be a server or any conventional personal computer, or any other processor-enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560. Examples of processors which may be used with system 550 include, without limitation, the Pentium® processor, Core i7® processor, and Xeon® processor, all of which are available from Intel Corporation of Santa Clara, Calif.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, or standards promulgated by the Institute of Electrical and Electronics Engineers (IEEE) including IEEE 488 general-purpose interface bus (GPIB), IEEE 696/S-100, and the like.

System 550 preferably includes a main memory 565 and may also include a secondary memory 570. The main memory 565 provides storage of instructions and data for programs executing on the processor 560, such as one or more of the functions and/or modules discussed above. It should be understood that programs stored in the memory and executed by processor 560 may be written and/or compiled according to any suitable language, including without limitation C/C++, Java, JavaScript, Pearl, Visual Basic, .NET, and the like. The main memory 565 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

The secondary memory 570 may optionally include an internal memory 575 and/or a removable medium 580, for example a floppy disk drive, a magnetic tape drive, a compact disc (CD) drive, a digital versatile disc (DVD) drive, other optical drive, a flash memory drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer-readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 590. Examples of external storage medium 595 may include an external hard disk drive or an external optical drive, or and external magneto-optical drive.

Other examples of secondary memory 570 may include semiconductor-based memory such as programmable read-only memory (PROM), erasable programmable read-only memory (EPROM), electrically erasable read-only memory (EEPROM), or flash memory (block oriented memory similar to EEPROM). Also included are any other removable storage media 580 and communication interface 590, which allow software and data to be transferred from an external medium 595 to the system 550.

System 550 may include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a built-in network adapter, network interface card (NIC), Personal Computer Memory Card International Association (PCMCIA) network card, card bus network adapter, wireless network adapter, Universal Serial Bus (USB) network adapter, modem, a network interface card (NIC), a wireless data card, a communications port, an infrared interface, an IEEE 1394 fire-wire, or any other device capable of interfacing system 550 with a network or another computing device.

Communication interface 590 preferably implements industry promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

In an embodiment, I/O interface 585 provides an interface between one or more components of system 550 and one or more input and/or output devices. Example input devices include, without limitation, keyboards, touch screens or other touch-sensitive devices, biometric sensing devices, computer mice, trackballs, pen-based pointing devices, and the like. Examples of output devices include, without limitation, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), and the like.

The system 550 also includes optional wireless communication components that facilitate wireless communication over a voice and over a data network. The wireless communication components comprise an antenna system 610, a radio system 615 and a baseband system 620. In the system 550, radio frequency (RF) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 may include various software modules (not shown).

Various embodiments may also be implemented primarily in hardware using, for example, components such as application specific integrated circuits (ASICs), or field programmable gate arrays (FPGAs). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, functions, and methods described in connection with the embodiments disclosed herein can be implemented or performed with a general purpose processor, a digital signal processor (DSP), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

Any of the software components described herein may take a variety of forms. For example, a component may be a stand-alone software package, or it may be a software package incorporated as a “tool” in a larger software product. It may be downloadable from a network, for example, a website, as a stand-alone product or as an add-in package for installation in an existing software application. It may also be available as a client-server software application, as a web-enabled software application, and/or as a mobile application.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

What is claimed:

1. A smart exercise device comprising:
a camera configured to capture video of a user of the smart exercise device;
a display;
a communication interface configured to allow the smart exercise device to communicate with a cloud service;
a processor configured to execute instructions, the instructions configured to cause the processor to perform the steps of:
present the user with a user interface at least partially via the display,
receive a selection of a trainer via the user interface and communicate the selection to the cloud service via the communication interface,
receive a selection of an exercise associated with the trainer via the user interface and communicate the selection to the cloud service via the communication interface,
download a video of the selected exercise via the communication interface, the video comprising a training portion,
cause the training portion of the video to be displayed on the display while simultaneously activating the camera in order to capture video of the user performing actions depicted in the training portion of the video,
analyze the captured video in order to match movements of the user depicted in the video to movements in the training portion of the video,
generate trackable feedback, and
provide the feedback via the user interface.

2. The smart exercise device of claim 1, wherein providing feedback comprises causing an avatar to be displayed on the display, wherein the avatar mimics the movements of the user, and color coding portions of the avatar to indicate whether the user is properly matching the movements in the training portion of the video.

3. The smart device of claim 1, wherein providing feedback comprises providing audible feedback via the user interface.

4. The smart device of claim 1, wherein analyzing the captured video comprises performing key point extraction, key feature extraction and key frame extraction.

5. The smart device of claim 1, wherein the instructions are further configured to cause the processor to compute performance metrics that are communicated to the cloud service vis the communication interface to the cloud service for storage.

6. A user device comprising:
a camera configured to capture video of a user;
a display;
a processor configured to execute instructions, the instructions configured to cause the processor to perform the steps of:
present the user with a user interface at least partially via the display,
receive a selection of a trainer via the user interface,
receive a selection of an exercise associated with the trainer via the user interface,
load a video of the selected exercise, the video comprising a training portion,
cause the training portion of the video to be displayed on the display while simultaneously activating the camera in order to capture video of the user performing actions depicted in the training portion of the video,
analyze the captured video in order to match movements of the user depicted in the video to movements in the training portion of the video,
generate trackable feedback, and
provide the feedback via the user interface.

7. The device of claim 6, wherein providing feedback comprises causing an avatar to be displayed on the display, wherein the avatar mimics the movements of the user, and color coding portions of the avatar to indicate whether the user is properly matching the movements in the training portion of the video.

8. The device of claim 6, wherein providing feedback comprises providing audible feedback via the user interface.

9. The device of claim 6, wherein analyzing the captured video comprises performing key point extraction, key feature extraction and key frame extraction.

10. The device of claim 6, wherein the instructions are further configured to cause the processor to compute performance metrics that are communicated to the cloud service vis the communication interface to the cloud service for storage.

11. The device of claim 6, further comprising a communication interface configured to allow the smart exercise device to communicate with a cloud service, wherein the instructions are further configured to cause the processor to communicate the trainer and the exercise selection to the cloud service via the communication interface and to download the video from the cloud service via the communication interface.

12. The device of claim 6, where in the selected exercise is part of a workout plan, and wherein the instructions are further configured to cause the processor to load a series of videos related to the workout plan.
